(19) United States
(12) Patent Application Publication
(10) Pub. No.: US 2005/0067129 A1
(43) Pub. Date: Mar. 31, 2005

(54) Method for the production of hollow ingots of a metallic material or of a plurality of metallic materials

(76) Inventors: Giorgio Enrico Falck, Milan (IT); Guido Talei Franzesi, Sirtori(Lecco) (IT)

Correspondence Address: NIXON & VANDERHYE, PC, 1100 N GLEBE ROAD, 8TH FLOOR, ARLINGTON, VA, 22201-4714, US

(21) Appl. No.: 10/491,884

(22) PCT Filed: Oct. 9, 2002
(86) PCT No.: PCT/IB02/04124

(30) Foreign Application Priority Data
Oct. 11, 2001 (IT) MI2001A002098

(51) Int. Cl. B22D 19/16; B23P 25/00

(52) U.S. Cl. 164/95; 164/348; 29/527.5

(57) ABSTRACT

A method for the production of ingots, hollow or made of a plurality of metallic materials, of a first metallic material which includes the following phases: casting a first metallic material in liquid state into an ingot mould provided with a heat insulated bottom; allowing the aforesaid first metallic material to solidify only partially to obtain, in the centre of the ingot mould, a substantially cylindrical zone of said first material still in liquid state; discharge said substantially cylindrical zone of said first material still in liquid state, to form a substantially cylindrical cavity in the ingot. Subsequent cooling of the already solidified metallic material remaining in the ingot mould makes it possible to obtain an ingot equipped with a cylindrical through cavity perfectly coaxial to the ingot obtained.

### FIELD OF THE INVENTION

The present invention relates to a method for the production of ingots of a metallic material and, in particular, to a method for the production of ingots with a central cylindrical cavity, if necessary coated with a second metallic material or with a cylindrical core of a different metallic material.

Hereinafter, “metallic material” shall relate to any metal or metallic alloy that can be cast into an ingot mould. Although the invention relates in particular to steel, it is not limited to this alloy, but extended to all metal-based alloys, such as aluminium, copper, titanium and nickel based alloys and to other metals.

### PRIOR ART

In the field of forging, i.e. in hot plastic processing of metallic materials, the production of pieces with axial symmetry with a central cavity, such as nozzles, ferrules and rings, is extremely important for the amounts produced. These hollow pieces are normally produced from solid ingots which are perforated using an operation technically referred to as broaching, after casting into the ingot mould and solidification.

In order to avoid the perforating phase, the production of hollow ingots has been proposed by casting into an ingot mould using a core, if necessary in refractory material, fixed to the bottom of the ingot mould by mechanical fixing means and shaped to allow the formation of a cylindrical through hole in the solidified ingot.

However, this technique has proved to be complicated to carry out, have high costs and there is a considerable risk of the metal being contaminated by the refractory material.

Moreover, a considerable number of finished products obtained from hollow ingots, after any forging, are subjected to further processing to coat the cavity of the finished piece with a layer of stainless metallic material to prevent corrosion.

This coating is produced with plating or electrodeposition processes which, performed by special carpentries, are particularly complicated and costly.

An object of the present invention is to provide a method for the production of ingots of a metallic material equipped with a cavity, if necessary coated in a different metallic material, without the drawbacks of prior art and therefore a method which is extremely simple and economical.

Another object of the present invention is to provide a method for the production of ingots of a first metallic material with a cavity coated or endowed with a core of a second metallic material, in which the two metallic materials are joined (i.e. alloyed) inseparably and without break of continuity, in order to avoid the formation of phenomena of scaling (chipping) or detachment during subsequent forging and/or heat treatment operations.

A further object of the present invention is to provide an apparatus particularly suitable to perform the claimed method for the production of ingots.

Yet another object of the present invention is to produce an apparatus for the aforesaid method which is capable of being structurally simple and highly reliable.

### SUMMARY OF THE INVENTION

These and other objects are attained by the method for the production of ingots of a metallic material according to the first independent claim and to the subsequent dependent claims and by the apparatus to obtain said method according to claim 10 and the subsequent dependent claims.

The method for the production of ingots of a first metallic material, according to the present invention, includes the following phases:
casting a first metallic material in liquid state into an ingot mould provided with a heat insulated bottom;
allowing the aforesaid first metallic material to solidify only partially to obtain, in the centre of the ingot mould, a substantially cylindrical zone of said first material still in liquid state;
discharge said substantially cylindrical zone of said first material still in liquid state, to form a substantially cylindrical cavity in the ingot.

Subsequent cooling of the metallic material already solidified remaining in the ingot mould makes it possible to obtain an ingot endowed with a cylindrical through hole perfectly coaxial to the ingot obtained.

The cylindrical cavity with a circular section also has extremely constant geometry along its entire length in the ingot and is surprisingly regular and symmetrical around the axis of the ingot.

Therefore, by controlling cooling, and hence solidification, of the ingot which advances from the side walls of the ingot towards its axis of symmetry, thanks to the heat insulated bottom of the ingot mould, it is possible to obtain a hollow ingot in an extremely simple and economical way, without having to resort to subsequent perforation.

In a particularly advantageous embodiment of the present invention, the phase of discharging the liquid central cylindrical zone is performed thanks to the presence of a hole which can be opened and/or resealed produced in the aforesaid heat insulated bottom.

According to a particular aspect of the present invention, the method also comprises the following phases of:
casting a second metallic material in liquid state inside the cavity formed in the ingot; and
allowing the second metallic material and the first metallic material to cool until total solidification, to form a core in said second metallic material inside the cavity formed in the ingot of said first metallic material.

The ingot thus obtained has, intimately alloyed, a central cylindrical core of a second metallic material which may be composed, advantageously, of a stainless metallic material, such as stainless steel, a nickel based super alloy, or a pure copper or nickel alloy.

According to a preferred aspect of the present invention, the method comprises, subsequent to the phase of discharging the first metallic material still in liquid state, the following phases of:
casting a second metallic material in liquid state inside the cavity formed in the ingot;
allowing the second metallic material to solidify only partially to obtain, in the centre of the ingot mould, a substantially cylindrical zone of the second material still in liquid state; and
discharging the substantially cylindrical zone of the second material still in liquid state, to form in said cavity of the ingot a core provided with a substantially cylindrical central hole.

In this way a hollow ingot is obtained, in an extremely simple and economical manner, of a first metallic material (for example steel), the cavity of which is coated with a layer of a second metallic material (for example stainless steel).

In a preferred embodiment of the method according to the invention, the metallic material still in liquid state which is discharged, for example through the hole provided in the heat insulated bottom, is collected in a “daughter” ingot mould positioned immediately downstream of the ingot mould with the heat insulated bottom.

In addition to the hollow ingot to be produced, a solid ingot of a smaller size is also obtained, thus making the process even more economical.

According to another aspect of the present invention, apparatus is provided for the production of ingots of the type comprising at least one ingot mould inside which one or more metallic materials in liquid state are cast, in which the ingot mould is positioned on a heat insulated bottom and in which said heated insulated bottom preferably comprises at least one discharge hole that can be opened and/resealed.

### BRIEF DESCRIPTION OF THE DRAWINGS

Some embodiments of the present invention shall now be described, purely as an example, with reference to the attached figures, in which:

FIG. 1 is a partially sectional schematic view of apparatus for the production of ingots according to a preferred aspect of the present invention;

FIG. 2 is a simplified block diagram which shows three particular embodiments of the process according to the present invention; and

FIG. 3 is a schematic perspective view of an ingot which may be obtained with a particular embodiment of the present invention.

### DETAILED DESCRIPTION OF SOME PREFERRED EMBODIMENTS OF THE INVENTION

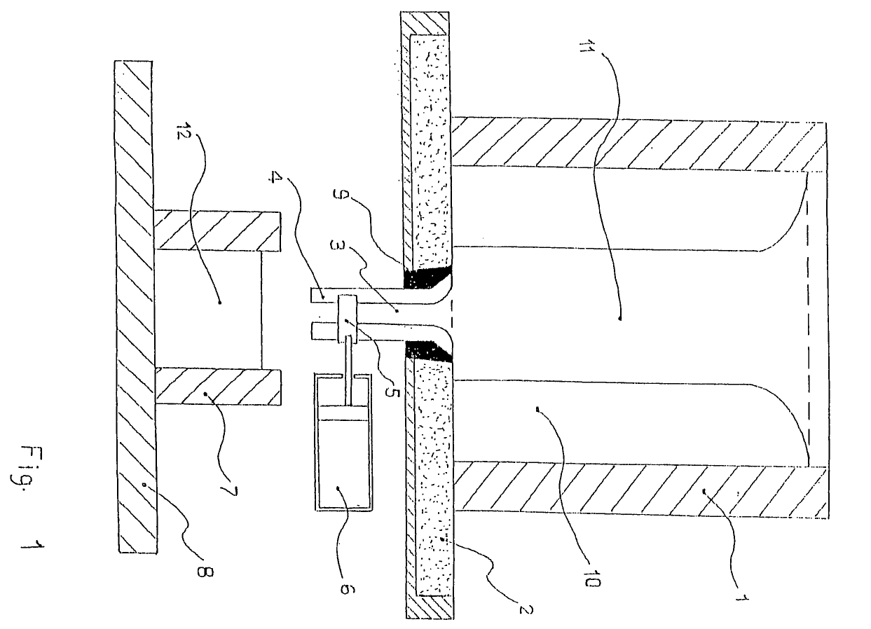

With reference to FIG. 1, the apparatus for the production of ingots according to the present invention comprises an ingot mould 1, preferably in cast iron in the case in which the ingot is obtained from a casting of steel, disposed on a bottom 2 made of heat insulated material, such as refractory bricks, cast or rammed refractory cements, or other insulating materials. According to prior art for ingot moulds “for forging”, the ingot mould 1, normally with a polygonal or round section, is disposed freely on the insulating bottom 2, although alternatively the ingot mould 1 could have an insulating bottom 2 anchored to it.

The insulating bottom 2 also comprises a hole 3 that can be opened and/or resealed, to which a discharge pipe 4 in refractory material and a device 5, 6 to open and close the hole 3 are connected. The function of the hole 3 is to allow discharge of the liquid material present in the ingot mould 1 after partial solidification of this material.

Nonetheless, to carry out the method according to the present invention, as shall be seen hereafter, the presence of the heat insulated bottom 2 is important, although the manner in which the liquid material is discharged is less important. Even more so, the type of device to close or open the hole 3 is not essential and may be formed of any system known to the art.

The apparatus for the production of ingots according to a particular aspect of the present invention may in fact be provided, alternatively to the presence of the hole 3 in the insulated bottom 2 and the device 5, 6, with a device (not shown) to raise and overturn the ingot mould 1-insulated bottom 2 assembly to discharge the metallic material still in liquid state, or with a device to raise the ingot mould 1 in relation to the insulated bottom 2 to allow discharge of the metallic material through the space which forms between the ingot mould 1 and the bottom 2.

In the apparatus for the production of ingots shown in FIG. 1, the device for opening and closing the discharge hole 3 is advantageously composed of a “valve” device, equipped with a gate (the “valve”) 5 which engages, blocking the outlet section, with the pipe 4 and which is made to translate alternately by a fluidically operated jack 6, such as a pneumatic jack 6. Operation of the jack 6 may conveniently be regulated by an automatic controller of known type.

According to a particular aspect of the apparatus, according to the present invention, the heat insulated bottom 2 comprises, in correspondence with the hole 3, one or more porous bricks 9 which may form a circular crown around this hole 3 and which have the function of allowing an inert gas, such as argon or nitrogen, to bubble through the metallic material cast into the ingot mould 1, still in liquid state. The purpose of bubbling an inert gas through the liquid metallic material in correspondence with the bottom 2 is to homogenize the temperature of the liquid material in the ingot mould 1 and, as may be appreciated from the description hereafter, also has the purpose of making the inner walls of the cylindrical cavity in the ingot, created with the method according to the invention, smooth or with a very small amount of roughness.

The apparatus comprises means to create and deliver a gas flow, not shown, used to bubble through the inert gas.

A particularly advantageous embodiment of the apparatus according to the present invention, also includes a “daughter” ingot mould 7 disposed functionally downstream (below) of the ingot mould 1, and in particular downstream of the discharge hole 3, to collect the liquid metallic material 12 which is discharged during the process of producing the ingot 10.

The “daughter” ingot mould 7, which may be made of cast iron or of a refractory material, rests on a plate, for example made of cast iron.

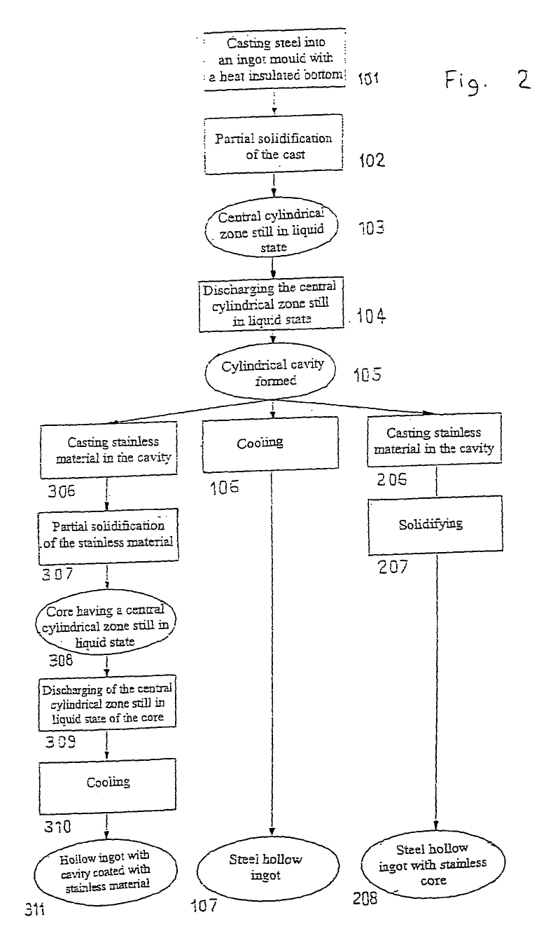

With reference now to FIG. 2, the method for the production of ingots according to the present invention, said method which may preferably be implemented thanks to the apparatus in FIG. 1, comprises the phases of:
casting (phase 101) a first metallic material, for example steel, in liquid state into the ingot mould 1 equipped with a heat insulated bottom 2;
controlling the solidification of the casting, for example using algorithms that can be implemented on a computer, to obtain only partial solidification (phase 102) of the ingot. The purpose of this phase 102 is to obtain (step 103), in the casting inside the ingot mould 1, a central zone 11 substantially cylindrical still in liquid state surrounded by a solid tubular zone which forms the ingot 10;
discharging (phase 104), if necessary by opening the discharge hole 3 of the bottom 2, the central zone 11 still in liquid state. The discharge phase of the liquid central zone 11 causes the formation (step 105) of a cylindrical central cavity in the ingot 10.

The partial solidification phase 102 of the casting, as mentioned above, causes the formation of a cylindrical central zone 11 in liquid state thanks to the fact that solidification advances from the side walls of the ingot mould 1 towards the axis of this ingot mould 1 and, owing to the presence of the heat insulated bottom 2, no solidification takes place in correspondence with the bottom portion of the ingot mould 1.

Moreover, control of solidification of the ingot, which determines the diameter of the liquid cylindrical zone 11, may be obtained by means of algorithms implemented on a computer and based on the diagrams of the state of the cast metallic material, on theoretical relations and on empirical coefficients. Alternatively, any other known method to control the size of the diameter of the liquid zone 11, comprising the empirical use of wooden rods dipped into the casting to control solidification, may be used.

Preferably at the end of the phase 102, or also during this phase, using the apparatus in FIG. 1, inert gas may be bubbled through the casting through the porous brick(s) 9, in correspondence with the liquid cylindrical zone 11.

Controlling solidification (phase 102) of the ingot 10 naturally has the purpose of determining the diameter of the cylindrical cavity that may be obtained after the phase 104 to discharge said liquid central zone 11.

The phase 104 of discharging the liquid zone 11 is therefore performed after a period of time calculated a priori, or detected during production of the ingot 10 and may be performed, in the apparatus shown in FIG. 1, thanks to translation of the gate, or valve, 5 operated by the pneumatic jack 6. Alternatively, in embodiments without the discharge hole 3 in the bottom 2, it is possible simply to rotate the ingot mould-heat insulated bottom assembly to overturn the remaining liquid part, or to raise the ingot mould 1 in relation to the heat insulated bottom 2 or even to move the latter in relation to the ingot mould 1, to facilitate downflow of the liquid cylindrical zone 11.

Advantageously, the liquid metallic material of the zone 11 is discharged inside the “daughter” ingot mould 7 so that the discharged material is not wasted, but may have commercial value as solid ingot 12.

Subsequent to the phase 104 to discharge the liquid cylindrical zone 11, the method for the production of ingots according to the present invention may have different phases according to the type of ingot that the operator wishes to obtain, that is ingots with a cylindrical through cavity, ingots with a coated cylindrical cavity or ingots with a coaxial core.

In the case in which the operator wishes to obtain (step 107) a hollow ingot of a single metallic material, for example steel, the method according to the present invention includes the following phase 106 of total cooling of the ingot 10. The hollow ingot 10, thus obtained, has a [symbol] entire length and with extremely smooth inner surfaces. Development of the through hole along the axis of the ingot mould 1, and therefore of the ingot 10, is surprisingly regular and the symmetry of the hole around said axis is exceptionally accurate.

In the case in which the operator wishes to obtain (step 208) an ingot of a first metallic material provided with a coaxial core of a second metallic material, for example stainless material such as stainless steel or a nickel super alloy, the method according to the invention includes the following phases of:
closing the discharge hole 3, in the apparatus of FIG. 1 translating the valve 5 to block the pipe 4, or returning the ingot mould-insulating bottom assembly to the vertical after overturning, or in any case restoring the function of the ingot mould 1 and the insulated bottom 2;
casting a second metallic material, for example stainless (phase 206), into the cavity created during the previous phase 105 of the method.

Casting of a second metallic material inside the cavity previously obtained in the ingot of a first metallic material (phase 206) causes re-melting of the surface of the first metallic material in correspondence with the inner wall of the cavity and thus intimate alloying of the second metallic material with the first in correspondence with the interface between the two metallic materials.

At this point, to obtain an ingot 10, for example in steel, provided with a central cylindrical core of a different metallic material to the material used for the ingot 10, although intimately alloyed to the same ingot 10, it is sufficient to leave the second metallic material, for example stainless, cast into the previously obtained cavity (phase 105) to solidify completely.

Bonding of the core produced through casting of the second metallic material to the inner wall of the through cavity formed of the first metallic material, prevents scaling or detachment of the core from the cavity during any subsequent processing of the ingot 10.

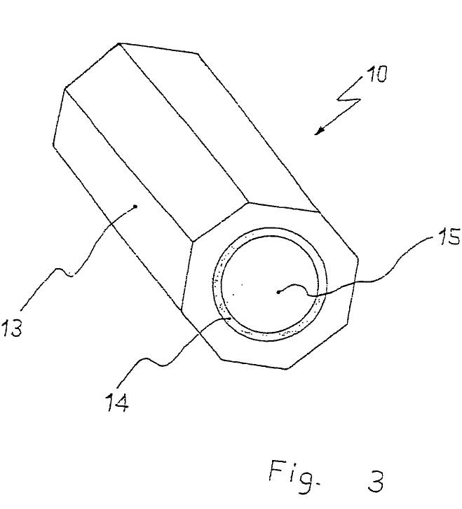

However, if the operator wishes to produce (step 311) an ingot 10, as shown in FIG. 3, with a cavity 15 with a coating 14 of a metallic material (for example stainless) differing from the one forming the outer walls 13 of the ingot 10 (for example steel), the method according to the present invention includes, after the phase 105, the phases of:
restoring the function of the ingot mould 1 and the insulated bottom 2, if necessary by resealing the hole 3;
casting (phase 306) a second metallic material, for example stainless, inside the cavity formed after the phase 105;
controlling solidification of the second cast material, for example using algorithms on a computer, to obtain only partial solidification (phase 307) of the second metallic material and to thus obtain (step 308) a core 14 with a substantially cylindrical liquid central zone;
discharging (phase 309), if necessary by opening the hole 3 or overturning the ingot mould-heat insulated bottom assembly, the liquid central zone of the partially solidified core;
allowing the perforated core 14, to cool, and thus solidify.

The ingot 10 obtained with this embodiment of the method according to the present invention, has a coating 14, the thickness of which is a function of the physical specifications of the second metallic material cast, the dimensions of the initial cavity of the ingot 10 and the solidification time of the second metallic material inside the ingot mould 1, of a cylindrical circular cavity 15. Owing to the partial melting of the first metallic material when the second metallic material which forms the coating is cast, the coating 14 is intimately alloyed to the walls 13 of the first metallic material and therefore the ingot 10 with the coated cavity obtained with the method according to the present invention may be subjected to subsequent processing, also on machine tools, without the coating 14 becoming detached from the outer walls 13 of the ingot 10.

In the embodiment shown in FIG. 3, moreover, the ingot 10 with cavity 15 equipped with coating 14, obtained with the method described hereinbefore, has a cylindrical outer profile with an octagonal bottom and is preferably made of steel with a stainless steel coating. This conformation of the outer profile, together with the metallic materials used, are nonetheless connected to technological choices of the process, such as the form of the ingot mould 1 and the type of ingot 10 to be produced, and therefore must be considered as a non-limiting example of the present invention.

1. Method for the production of ingots of a first metallic material, characterized by the following phases:
casting of said first metallic material in liquid state inside an ingot mould equipped with a heat insulated bottom;
allowing said first metallic material in liquid state to solidify only partially as long as, in the centre of the ingot mould, a substantially cylindrical zone of said first material still in liquid state is obtained;
discharging said substantially cylindrical zone of said first material still in liquid state, to form a substantially cylindrical cavity in the ingot.

2. Method as claimed in claim 1, characterized in that said substantially cylindrical zone of said first material still in liquid state is discharged inside a second ingot mould functionally positioned downstream of said ingot mould.

3. Method as claimed in claim 1, in which during said phase of allowing said first metallic material in liquid state to solidify only partially, an inert gas is bubbled through from said insulated bottom.

4. Method as claimed in claim 1, in which said phase of discharging said substantially cylindrical zone of said first material still in liquid state is implemented through a discharge hole that can be opened and/or resealed provided in said heat insulated bottom.

5. Method as claimed in claim 1, characterized in that said phase-of discharging said substantially cylindrical zone of said first material still in liquid state is performed by overturning the ingot mould-insulated bottom assembly or by discharge from the bottom by raising the ingot mould.

6. Method as claimed in claim 1, characterized in that said phase to discharge said substantially cylindrical zone of said first material still in liquid state, is followed by the phase of:
casting a second metallic material in liquid state inside said cavity formed in the ingot.

7. Method as claimed in claim 6, characterized by the subsequent phase of:
allowing said second metallic material and said first metallic material to cool until completely solidified, to form a core of said second metallic material inside the cavity formed in the ingot of said first metallic material.

8. Method as claimed in claim 6, characterized by the subsequent phases of:
allowing said second metallic material in liquid state to solidify only partially, as long as, in the centre of the ingot mould, a substantially cylindrical zone of said second material still in liquid state is obtained;
discharging said substantially cylindrical zone of said second material still in liquid state, to form in said cavity of the ingot a core equipped with a substantially cylindrical central hole.

9. Method as claimed in claim 1, characterized in that said first metallic material is steel and said second metallic material is stainless steel.

10. Apparatus for the production of ingots of the type comprising at least one ingot mould inside which one or more metallic materials in liquid state are cast, characterized in that said ingot mould comprises or is positioned on a heat insulated bottom.

11. Apparatus as claimed in claim 10, characterized in that said heat insulated bottom comprises at least one discharge hole that can be opened and/or reseated.

12. Apparatus as claimed in claim 10, characterized in that it comprises a device suitable to overturn the ingot mould-heat insulated bottom assembly to empty the residual liquid.

13. Apparatus as claimed in claim 10, characterized in that it comprises a device suitable to raise the ingot mould from said insulated bottom to discharge the residual liquid metallic material through the space created between the bottom and the ingot mould.

14. Apparatus as claimed in claim 10, characterized in that said heat insulated bottom comprises refractory bricks and/or cast or rammed refractory cements.

15. Apparatus as claimed in claim 10, in which said heat insulated bottom comprises one or more porous bricks through which an inert gas, or a mixture of inert gases, is made to bubble.

16. Apparatus as claimed in claim 15, in which said one or more porous bricks are disposed around said discharge hole.

17. Apparatus as claimed in claim 11, characterized in that it comprises a device for opening/closing said discharge hole.

18. Apparatus as claimed in claim 17, in which said device for opening/closing said discharge hole comprises a fluidically operated jack and means for remote control of said jack.

19. Apparatus as claimed in claim 11, characterized in that it comprises, downstream of said discharge hole, a second ingot mould.

20. Ingot of a first metallic material with a central cylindrical cavity obtained with the method claimed in claim 1.

21. Ingot of a first metallic material with at least one central cylindrical core of a second metallic material, obtained with the method claimed in claim 7.

22. Ingot of a first metallic material with a central cylindrical cavity coated in a second metallic material, obtained with the method claimed in claim 8.
